(19) United States
(12) Patent Application Publication
(10) Pub. No.: US 2024/0206687 A1
(43) Pub. Date: Jun. 27, 2024

(54) SYSTEMS, METHODS, AND APPARATUSES FOR MEASURING AND INDICATING PRODUCT USAGE AND PROVIDING USER FEEDBACK WITH A PUMP ACTUATED PERSONAL CARE PRODUCT DISPENSING SYSTEM

(71) Applicant: IM Pro Makeup ny lp, New York, NM (US)

(72) Inventors: Oran Holtzman, New York, NY (US); Maayan Gianella, New York, NY (US)

(73) Assignee: IM Pro Makeup ny lp, New York, NY (US)

(21) Appl. No.: 18/402,521

(22) Filed: Jan. 2, 2024

Related U.S. Application Data
(63) Continuation-in-part of application No. 17/454,850, filed on Nov. 15, 2021, now abandoned.
(63) Continuation-in-part of application No. 16/947,933, filed on Aug. 24, 2020, now Pat. No. 11,117,149.
(60) Provisional application No. 63/478,015, filed on Dec. 30, 2022.

(51) Int. Cl. A47K 5/12

(52) U.S. Cl. CPC A47K 5/1217; A47K 5/1205

(57) ABSTRACT

A liquid dispenser includes a liquid pump and bottle containing liquid product. A product management system manages helps track usage information, e.g., number of pump actions, how much product in a dispenser has been used or remains. The user may provide a seller with feedback based on a use indicator. A system tracks usage, maintains usage database, processes machine learning and artificial intelligence to acquire understanding of usage and facilitates replenishing personal care liquid product. The dispenser includes a product usage indicator and/or feedback mechanism or dispensing metering device for detecting pump actuation. The usage indicator mechanism may include a display component adapted to display a number or other indicia representing number of pump actions performed or remaining. The indicia provides the user and/or seller with an approximation of one or both of the amount of product used/dispensed and the amount of product remaining in the dispenser.

### INCORPORATION BY REFERENCE

The present application incorporates by reference each of the following: U.S. patent application Ser. No. 17/454,850 (Atty Docket IM012US1), entitled SYSTEMS, METHODS, AND APPARATUSES FOR A REUSABLE DROPPER AND BOTTLE ASSEMBLY AND REPLACEMENT CAPSULE FOR PERSONAL CARE PRODUCT DISPENSING SYSTEM, filed 15 Nov. 2021, by Holtzman et al., which claims the benefit of priority as a continuation-in-part to U.S. patent application Ser. No. 16/947,933 (Atty Docket IM003US1), entitled SYSTEMS, METHODS, AND APPARATUSES FOR A CARTRIDGE DISPENSING SYSTEM AND RETENTION MECHANISM, filed 24 Aug. 2020, by Holtzman, which claims the benefit of priority to U.S. Provisional Pat. App. No. 62/890,565 (Atty Docket IM003PRV), entitled SYSTEMS, METHODS, AND APPARATUSES FOR A CARTRIDGE DISPENSING SYSTEM AND RETENTION MECHANISM, filed 22 Aug. 2019, by Holtzman, and claims the benefit of priority to U.S. Provisional Pat. App. No. 63/478,015 (Atty Docket IM016PRV), entitled SYSTEMS, METHODS, AND APPARATUSES FOR MEASURING AND INDICATING PRODUCT USAGE AND PROVIDING USER FEEDBACK WITH A PUMP ACTUATED PERSONAL CARE PRODUCT DISPENSING SYSTEM, filed 30 Dec. 2022, by Holtzman, each of which is incorporated by reference herein in its entirety.

### FIELD OF THE INVENTION

The present application relates to dispensing systems for dispensing fluid-based personal care products including hair care, skin care, body care, and cosmetic products and in particular to pump bottle type dispensing systems. The present application further relates to a system to facilitate re-ordering or replenishing products and for capturing user-feedback data and implementing product related procurement, replenishment, ordering, and inventory management.

### BACKGROUND OF THE INVENTION

A wide range of personal care products, including hair care, skin care or skincare, body care, cosmetics, foundation, concealer, primer, and a range of other beauty products, that consumers replenish frequently. As used herein, personal care and beauty care are used interchangeably to cover the afore-mentioned broad range of products. Often personal care products are selected based on consumer experience with trying such products and achieving a certain result. For these products, rather than seeking newness and variety, consumers purchase the same product for consistency in application and results.

Many personal product dispensing devices include bottles that are colored or opaque or covered with graphic and branding labels resulting in the contents of the bottle being obscured and not easily viewed by the user. Often the user can only try to “feel” how much product remains in a bottle or container based on weight. Many users are not aware of how close to empty a bottle is until the last dregs of liquid product are released on a final pump or actuation of the dispensing mechanism. Depending on delivery times for online orders or availability of the frequently used product at a retail brick and mortar type store, the customer/product user may be without their personal care product for an annoying amount of time. Such delay in replenishment also leads to reduced orders and sales of the product to the detriment of the seller. In addition, the user may feel the need to submit a “rush” delivery order. This means the consumer ends up paying more to replenish personal care product supply.

What is needed is a product and in particular a personal care product dispensing system that provides for uninterrupted product use and more efficient replenishment while maintaining an elevated consumer experience that is both seamless and fun. Such a product would increase customer loyalty to the brand providing it by improving customer experience with replenishing product.

Such a replenishment mechanism would also enable the brand to provide a replenishment or product subscription service and to increase customer “stickiness” by increasing seller-user interaction and avoiding gaps in time following depletion of product before replenishment. Such a process would increase value and avoid customer frustration.

What is needed is a product usage measuring and indicating system capable of providing a user with visual indication, which may represent a condition or property of the product or dispenser.

What is needed is an improved atmospheric-type pump for effectively dispersing liquid personal care product having a viscosity consistent with atmospheric straw-type dispensing mechanisms.

### SUMMARY OF THE INVENTION

The present invention is a product that supports ongoing replenishment by providing a product dispenser configured to provide a user with feedback or indication of how much product in a dispenser remains. The present invention also provides a system to facilitate replenishing personal care liquid products. The product dispensing system may be in the form of an atmospheric-type pump mechanism with “straw”-based dispensing tube coupled with a pump actuator and product bottle or container. The product may also be in the form of an air-less pump. The dispenser includes a product usage indicator and/or feedback mechanism. For example, the usage indicator mechanism may include a “counter” or dispensing metering device capable of detecting each actuation of the dispenser pump mechanism. The usage indicator mechanism may include a display component adapted to display, e.g., via a viewing window or the like, a number or other indicia representing number of pump action or amount of remaining pump actuations. The indicia will provide the user with an approximation of one or both of the amount of product used/dispensed and the amount of product remaining in the dispenser. In the alternative, the user may not understand the indicia or indicator or indication to represent anything in particular. In this case the seller reaches out to the customer to find out what the status of the indicia or indicator is and internally or centrally understands the meaning of the indicia status.

The product usage measuring and indicating feature is capable of providing a user with visual indication representing an item of interest. For example, the indication may represent a condition or property of the product or dispenser. For example, the indication may represent how many times the pump has been actuated, how much product has been used or remains in a product dispensing bottle. While the user can visually detect the indication on the bottle, the user may or may not understand the significance of the indication, i.e., may not understand the indication represents a usage, number of pumps actuated, amount of product remaining, or amount of product used. For instance, the indication may be a number or set of numbers or may be an image or color code. This may be intended by a seller such that the seller collects information from the user for use in aggregate across a set of customers or individually to track usage and need for product replenishment at the individual level. As part of an overall product replenishment program or customer loyalty program or both, the product source/seller may utilize an automated communication protocol to periodically or in a defined manner contact the customer to inquire about the indicator status and to update associated user and/or product data records.

By providing a user feedback mechanism the improved system informs the user of usage and instills an awareness of the need to replenish product prior to depletion. The indicia may represent or correspond to a suggested action to be taken by the user, such as visiting the product seller website to place or confirm an order for new product. In this manner, the invention provides a more efficient, satisfying, and cost-effective approach for customers. In this manner the system makes it less expensive for a company to replenish the consumer's product and, therefore, it makes it less expensive for the consumer to continue buying the same or other compatible products for replacement. This approach has the added benefit of increasing consumer loyalty.

In a further alternative, the invention may be used in connection with a reusable product dispenser and series of replacement cartridges. For example, when the consumer uses up or depletes personal care product, the consumer can easily replace them. For example, the consumer may open the dispenser at the top cover, which may be completely removable in a threaded manner. The consumer then removes the spent capsule of product and replaces it with a new capsule of the same or other type of product. The consumer then replaces the cover on the dispenser and proceeds to use the dispenser as before. The capsules in this manner provide added benefit as they are comprised of significantly thinner material than the reusable dispenser and are therefore significantly less expensive to make and less expensive to ship. They also have a reduced environmental impact. To make it easy for the consumer to refill the product correctly—specifically to make sure they are replacing a used capsule with the same type of product—the capsules may be color-coded or themed or designed with different patterns that are easily recognizable. The counter may be reset so that the usage measuring and indicating function resets to reflect a full product reservoir.

The present invention may be applied to a wide range of personal care products. The dispenser and replaceable capsule system can be applied to any liquid product consistent with the dispenser.

In a first embodiment, the present invention provides a liquid dispenser adapted to dispense a liquid personal care product, the liquid dispenser comprising: a liquid product housing defining an interior product reservoir configured to receive and contain liquid product and having an output portion, the output portion including an outwardly protruding neck defining an opening and configured to receive and support a pump tube assembly; the pump tube assembly comprising an elongated tube portion disposed within the liquid product reservoir and a pump actuator interface supported by the neck; a pump actuator assembly having an inlet and an outlet, the pump actuator assembly having a tube interface component adapted to mate with the pump actuator interface; and a product usage measuring and indicating mechanism configured to detect incremental use of the dispenser to dispense liquid product from the product reservoir and to indicate a status of the incremental usage.

The liquid dispenser of the first embodiment may be further characterized in any one or more of the following manners: wherein the product usage measuring and indicating mechanism includes a counter adapted to count each actuation of the pump actuator assembly; wherein the product usage measuring and indicating mechanism includes a display in clear view from the exterior of the dispenser and showing in successive manner one indicia from a set of indicia representing a usage status; wherein the set of indicia include one or more of the following: a series of numbers, a set of graphical images; a set of colors; a series of shaded images; and a set of markings; wherein the product usage measuring and indicating mechanism comprises a display wheel on which is disposed for sequential viewing a set of indicia; a primary gear wheel connected to the display wheel in a co-axial manner and configured to drive the display wheel in a rotating fashion about a common axis; wherein the product usage measuring and indicating mechanism further comprises a tab configured to selectively cause the primary wheel to rotate upon a pre-defined number of pumping actions of the pump actuator assembly; wherein the product usage measuring and indicating mechanism further comprises a secondary gear wheel configured to rotate about a second axis, and wherein the tab causes the secondary gear wheel to rotate upon a predefined instance of pumping actions of the pump actuator assembly; wherein the product usage measuring and indicating mechanism further comprises a gear and axis base configured to support the display wheel and the primary gear wheel and the primary axis, wherein the gear and axis base is received within the tube interface of the pump actuator assembly.

The liquid dispenser of the first embodiment may be further characterized in any one or more of the following manners: wherein the elongated tube portion includes a first end supported by the pump actuator interface and defining an outlet, and a second end defining an inlet in communication with liquid product contained in the reservoir; wherein the pump actuator interface and the tube interface provide a continuous path for liquid from the reservoir to pass into and through the pump tube assembly and the pump actuator assembly and upon actuation of the pump actuator assembly, cause liquid product contained in the reservoir to be drawn into the tube portion via the tube inlet, flow through the pump tube assembly, through the pump actuator assembly, and exit the pump actuator outlet for dispensing of the liquid product for use by a user.

The liquid dispenser of the first embodiment may be further characterized in any one or more of the following manners: wherein the neck includes a threaded exterior and the pump actuator includes an internal threaded portion adapted to threadingly mate with the threaded exterior of the neck; wherein the liquid dispenser is adapted to removably receive a replaceable capsule and dispense a liquid personal care product contained in an installed capsule and the usage measuring and indicating mechanism is adapted to be reset upon product replenishment; wherein the pump actuator interface is configured to alternately attach to and detach from the housing to allow, alternately, for insertion and removal of the cartridge to facilitate replacement of a spent cartridge with a fresh replacement cartridge; wherein the pump engine is spring-biased and is actuated upon a user depressing a spray head provided on the liquid spray pump assembly to cause the pump engine to draw a pre-determined amount of liquid from the reservoir; wherein the housing further comprises a support component adapted to removably attach to the top of the housing, the support component having a pump engine support portion adapted to join with and support the liquid spray pump assembly; wherein the housing includes a threaded circumference at the housing top, and the support component includes a first set of threads adapted to mate with and removably secure the support component with the threaded circumference; wherein the support component includes a cartridge support portion adapted to mate with and support the cartridge; wherein the cartridge includes a threaded neck, and the support component includes a second set of threads adapted to mate with and removably secure the support component with the cartridge threaded neck; and/or further comprising a cap adapted to be removably attached to the housing and adapted to cover and protect an exposed portion of the pump actuator assembly, including the outlet, and adapted to prevent undesired actuation of the pump actuator assembly.

In a second embodiment the present invention provides a method of dispensing liquid product and measuring and indicating usage status, the method comprising the steps of: providing a liquid dispenser adapted to dispense a liquid personal care product from a product reservoir configured to receive and contain liquid product; actuating a pump actuator assembly to cause liquid product contained in the product reservoir to flow out an output portion of the liquid dispenser, the pump actuator assembly having an inlet and an outlet; detecting and displaying, by a product usage measuring and indicating mechanism, a usage condition, the product usage measuring and indicating mechanism configured to detect incremental use of the dispenser to dispense liquid product from the product reservoir and to indicate a usage status of the incremental usage; and providing on the dispenser a clear view of the usage status indication.

The method of dispensing liquid product and measuring and indicating usage status may be further characterized in any one or more of the following manners: counting, by the product usage measuring and indicating mechanism, each actuation of the pump actuator assembly; displaying, by the product usage measuring and indicating mechanism, in clear view from the exterior of the dispenser indicia from a set of indicia representing a usage status; wherein the set of indicia include one or more of the following: a series of numbers, a set of graphical images; a set of colors; a series of shaded images; and a set of markings; wherein the product usage measuring and indicating mechanism comprises a display wheel on which is disposed for sequential viewing a set of indicia; a primary gear wheel connected to the display wheel in a co-axial manner and configured to drive the display wheel in a rotating fashion about a common axis; causing, by the product usage measuring and indicating mechanism, the primary wheel to rotate upon a pre-defined number of pumping actions of the pump actuator assembly; causing, by the product usage measuring and indicating mechanism, a secondary gear wheel to rotate about a second axis, and wherein a tab causes the secondary gear wheel to rotate upon a predefined instance of pumping actions of the pump actuator assembly; wherein the product usage measuring and indicating mechanism further comprises a gear and axis base configured to support the display wheel and the primary gear wheel and the primary axis, wherein the gear and axis base is received within the tube interface of the pump actuator assembly.

### BRIEF DESCRIPTION OF THE DRAWINGS

To facilitate a full understanding of the present invention, reference is now made to the accompanying drawings, in which like elements are referenced with like numerals. These drawings should not be construed as limiting the present invention but are intended to be exemplary and for reference.

FIGS. 1A-1C respectively provide views of an exemplary liquid dispenser for dispensing personal care liquid products contained in a bottle or housing, and including a usage measuring and indicating mechanism in accordance with a first embodiment of the present invention. FIG. 1A is a isometric/perspective view of an assembled dispenser product, FIG. 1B is a cross-section of the protective outer cap assembly, and FIG. 1C is an exploded view of the dispenser with an expanded view of an exemplary product usage measuring and indicating mechanism of the present invention.

FIGS. 2A-2B provide front views illustrating components of the liquid dispenser of FIG. 1A according to an embodiment of the present invention; FIG. 2A provides a cross-section view of the dispenser housing and pump tube assembly, and FIG. 2B provides a front view of the dispenser housing and pump tube assembly.

FIGS. 3A-3E provide cross-section and other views of an exemplary pump actuator assembly for use with the liquid dispenser of FIG. 1A in accordance with a first embodiment of the present invention. FIG. 3A provides a front view of the pump actuator assembly showing a display window associated with an exemplary embodiment of the usage measuring and indicating mechanism. FIG. 3B provides a top view of the pump actuator assembly. FIG. 3C provides a front cross-sectional view of the pump actuator assembly associated with an exemplary embodiment of the usage measuring and indicating mechanism. FIG. 3D provides a side cross-sectional view of the pump actuator assembly showing a display window associated with an exemplary embodiment of the usage measuring and indicating mechanism. FIG. 3E provides a side cross-sectional view of the pump actuator showing the exemplary embodiment of the usage measuring and indicating mechanism.

FIGS. 4A-4B provide perspective and front views of an exemplary tube interface component for use in the exemplary pump actuator assembly for use with the liquid dispenser of FIG. 1A in accordance with a first embodiment of the present invention.

FIG. 4C provides a side cross-section view of the exemplary tube interface component showing a usage display window for use in the exemplary pump actuator assembly for use with the liquid dispenser of FIG. 1A in accordance with a first embodiment of the present invention.

FIG. 5A provides a front perspective view of the exemplary usage measuring and indicating mechanism for use with the exemplary pump actuator assembly for use in accordance with the liquid dispenser of FIG. 1A in accordance with a first embodiment of the present invention.

FIG. 5B provides a top-down perspective view of the exemplary usage measuring and indicating mechanism for use with the exemplary pump actuator assembly for use in accordance with the liquid dispenser of FIG. 1A in accordance with a first embodiment of the present invention.

FIG. 5C provides a front view of the exemplary usage measuring and indicating mechanism for use with the exemplary pump actuator assembly for use in accordance with the liquid dispenser of FIG. 1A in accordance with a first embodiment of the present invention.

FIG. 5D provides an exploded perspective view of the exemplary usage measuring and indicating mechanism for use with the exemplary pump actuator assembly for use in accordance with the liquid dispenser of FIG. 1A in accordance with a first embodiment of the present invention.

FIG. 6 provides a front perspective view of an exemplary pump tube assembly for use in accordance with the liquid dispenser of FIG. 1A in accordance with a first embodiment of the present invention.

FIG. 7 illustrates an exemplary method or process of implementing a customer interaction and product replenishment operation for use in accordance with the liquid dispenser of FIG. 1A in accordance with a second embodiment of the present invention.

FIG. 8 illustrates an exemplary schematic diagram of client-server architecture for use in accordance with capturing data and generating messages for use with the liquid dispenser of FIG. 1A in accordance with a third embodiment of the present invention.

### DETAILED DESCRIPTION OF THE INVENTION

The present invention will now be described in more detail with reference to exemplary embodiments as shown in the accompanying drawings. While the present invention is described herein with reference to the exemplary embodiments, it will be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

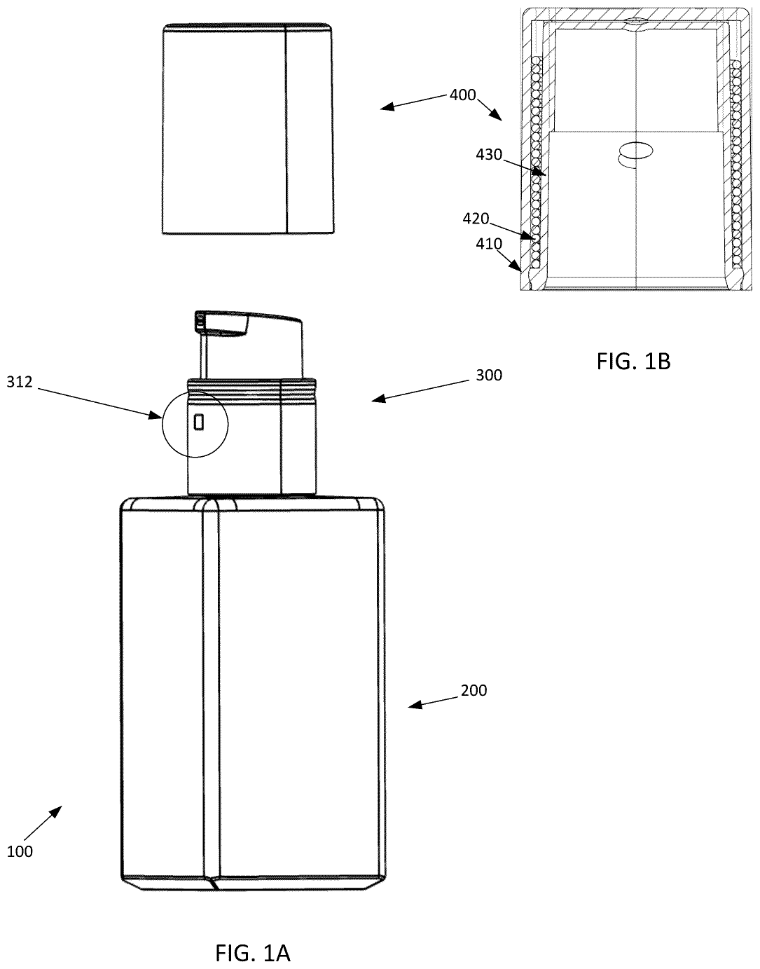

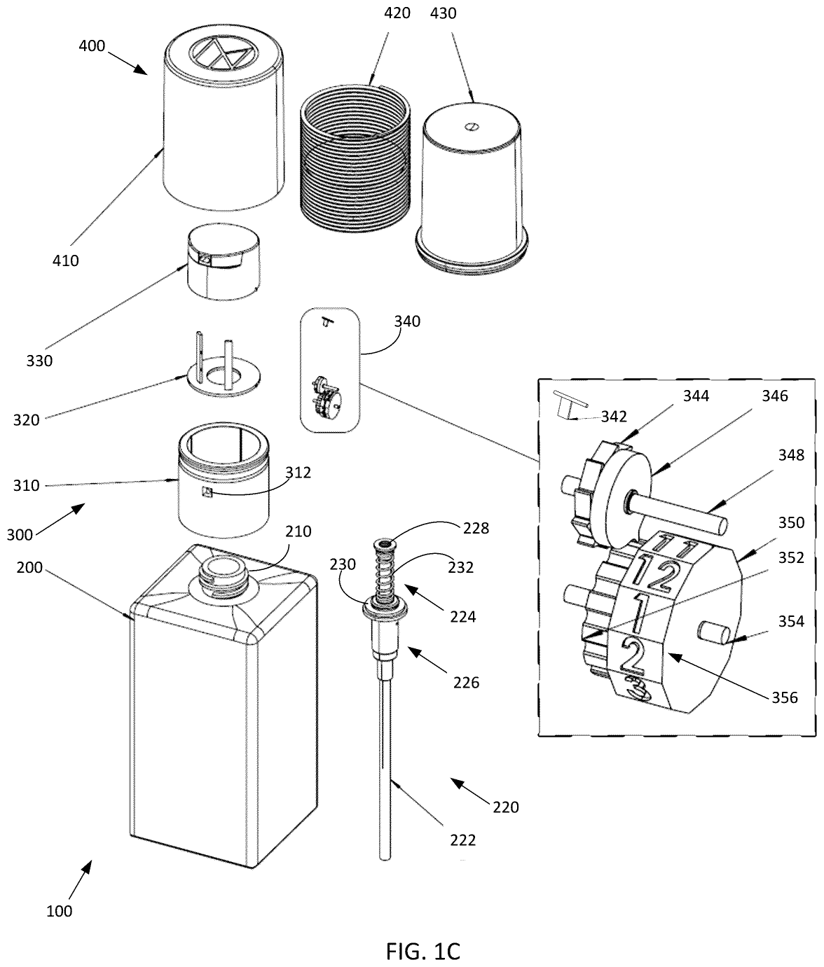

FIGS. 1A-1C respectively provide views of an exemplary liquid dispenser for dispensing personal care liquid products contained in a bottle or housing, and including a usage measuring and indicating mechanism in accordance with a first embodiment of the present invention. FIG. 1A is an isometric/perspective view of an assembled dispenser product 100 and is shown having a housing or body or bottle 200, a pump actuator assembly 300 (having a display window 312), and a protective outer cap assembly 400. FIG. 1B is a cross-section of the protective outer cap assembly 400 and is shown having an outer cap 410, in inner cap 430 and sandwiched therebetween a weight or intermediate component 420. The cap assembly 400 protects the pump assembly 300 to guard against damage and unintended dispensing of product.

FIG. 1C is an exploded view of the dispenser 100 with an expanded view of an exemplary product usage measuring and indicating mechanism 340 of the present invention. As shown, the dispenser 100 includes a bottle or body or housing 200 in which is at least partially received a pump tube assembly 220. Dispenser 100 includes a pump actuator assembly 300 includes a tube interface 310, a base or support component 320 for supporting a product usage measuring and indicating mechanism 340, a protective cap assembly 400. The pump tube assembly 220 includes an elongated tube or tube portion 222, an intermediate portion 226, a pump interface 224 including a spring or biasing member 232, a pump base collar 230 and a top end 228. The pump interface 224 is configured to operate with tube interface 310 to perform a pumping action and product dispensing action when the dispenser is used.

As shown in FIG. 1C, the product usage measuring and indicating mechanism 340 includes a counter assembly adapted to count each actuation of the pump actuator assembly 300. For instance, the tube interface 310 includes a display 312 in clear view from the exterior of the dispenser 100. The product usage measuring and indicating mechanism 340 includes a display wheel 350 on which is disposed for sequential viewing a set of indicia 356. A primary gear wheel 352 is connected to the display wheel 350 in a co-axial manner and is configured to drive the display wheel in a rotating fashion about a common primary axis 354. The product usage measuring and indicating mechanism 340 further includes a tab 342 configured to selectively cause the primary wheel 352 to rotate upon a pre-defined number of pumping actions of the pump actuator assembly.

As shown, the product usage measuring and indicating mechanism 340 includes a secondary or intermediate gear wheel 344 configured to rotate about a second or secondary axis 348. The tab 342 causes the secondary gear wheel 344, and thereby cause a connected single tooth wheel 346 to rotate upon a predefined instance of pumping actions of the pump actuator assembly 300. This thereby causes the display wheel to also rotate about primary axis 354. The product usage measuring and indicating mechanism 340 includes a gear and axis base or support 320 configured to support the display wheel 350 and the primary gear wheel 352 and the primary axis 354 as well as the secondary gear wheel 344 and single tooth wheel 346 about axis 348. The display wheel 350, the primary gear wheel 352, the primary axis 354, the secondary gear wheel 344, the single tooth wheel 346, and the axis 348 are assembled and mounted onto the gear and axis base 320 to form the usage measuring and indicating assembly 340, which is received within a hollow area defined within the tube interface 310 of the pump actuator assembly 300.

In one exemplary embodiment, the display wheel 350 includes a set of indicia 356, which are configured to be displayed via window or opening 312 on the tube interface 310. In one manner of use, the set of indicia 356 is displayed in successive manner with each indicium from the set of indicia representing a usage status. For example, the set of indicia may include one or more of the following: a series of numbers, a set of graphical images; a set of colors; a series of shaded images; and a set of markings; wherein the product usage measuring and indicating mechanism comprises.

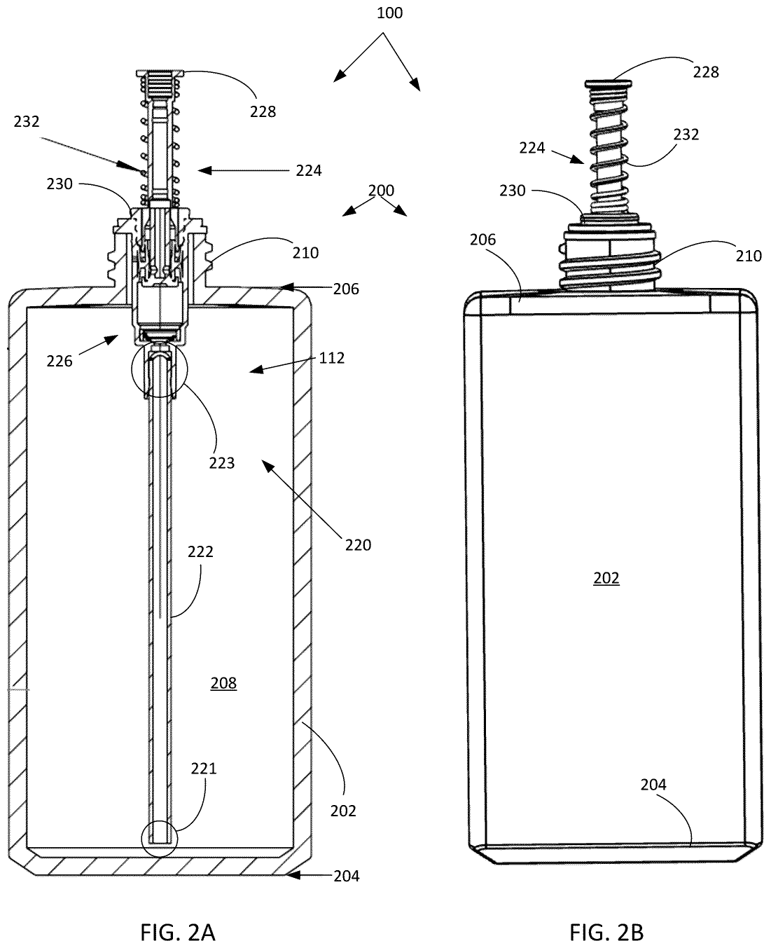

FIGS. 2A-2B provide front views illustrating components of the liquid dispenser of FIG. 1A according to an embodiment of the present invention; FIG. 2A provides a cross-section view of the dispenser housing and pump tube assembly, and FIG. 2B provides a front view of the dispenser housing and pump tube assembly. As shown in FIG. 2A, the pump tube assembly 220 includes an elongated tube or tube portion 222, an intermediate portion 226, a pump actuator interface 224 including a spring or biasing member 232, a pump base collar 230 and a top end 228. The elongated tube portion 222 of the pump tube assembly 220 is inserted into the reservoir 208 of the bottle or body or housing 200. As shown the intermediate tube portion 226 supports the tube portion 222 with a first end supported by the pump actuator interface and defining an outlet 223, and a second opposite end defining an inlet 221 in communication with liquid product contained in the reservoir 208. In this configuration, the pump actuator interface 224 and the tube interface (310) provide a continuous path for liquid from the reservoir 208 to pass into and through the pump tube assembly 220 and the pump actuator assembly (300) and upon actuation of the pump actuator assembly, cause liquid product contained in the reservoir to be drawn into the elongated tube portion 222 via the tube inlet 221, flow through the pump tube assembly, through the pump actuator assembly, and exit the pump actuator outlet for dispensing of the liquid product for use by a user.

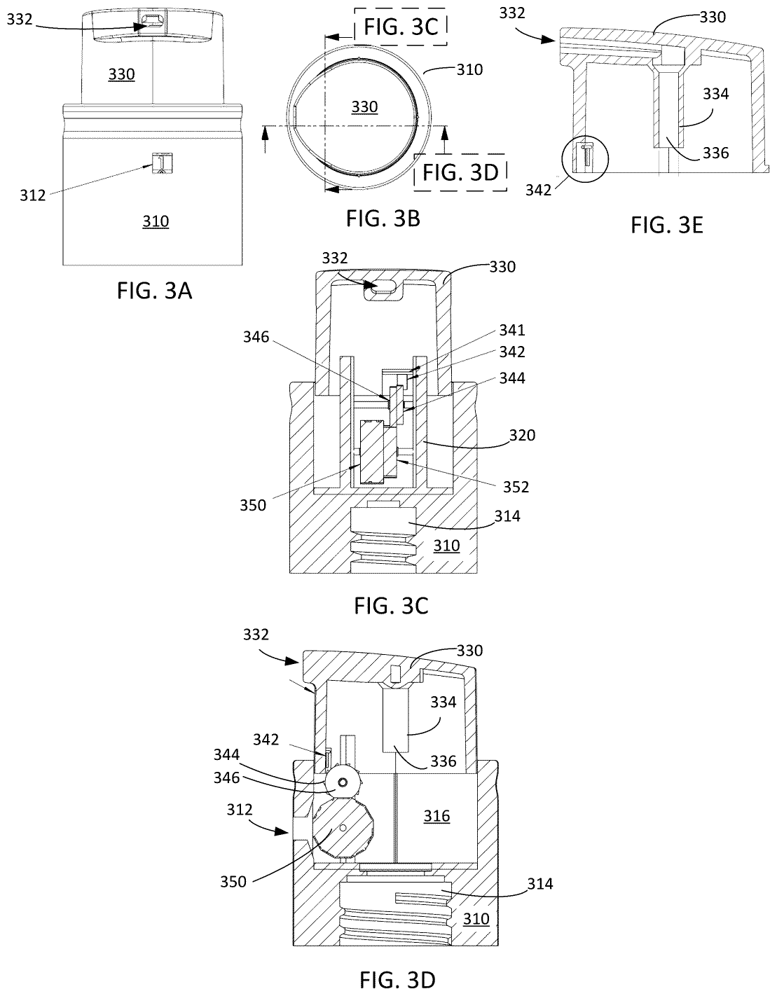

As shown in FIGS. 2A and 3C, bottle or housing 200 includes a threaded neck 210 to provide a threaded exterior and the tube interface 310 of the pump actuator 300 includes an internal threaded portion 314 adapted to threadingly mate with the threaded exterior of the neck 210 to thereby sealingly combine or connect the pump assembly 300 with the housing 200.

In one alternative embodiment, not shown, the opening formed at the neck 210 and the circumference of the tube interface 310 may be enlarged and adapted or configured to receive a replacement cartridge as an alternative to replenishing the entire dispenser product. In this alternative embodiment, the liquid dispenser is adapted to removably receive a replaceable capsule and dispense a liquid personal care product contained in an installed capsule and the usage measuring and indicating mechanism is adapted to be reset upon product replenishment. In this embodiment, the pump actuator assembly 300 is configured to alternately attach to and detach from the housing 200 to allow, alternately, for insertion and removal of the cartridge to facilitate replacement of a spent cartridge with a fresh replacement cartridge. In this embodiment, the pump tube assembly may be integral with the replacement cartridge or may be reused.

FIGS. 3A-3E provide cross-section and other views of an exemplary pump actuator assembly for use with the liquid dispenser of FIG. 1A in accordance with a first embodiment of the present invention. FIG. 3A provides a front view of the pump actuator assembly 300 showing a display window 312 associated with an exemplary embodiment of the usage measuring and indicating mechanism 340. In this embodiment, the pump assembly 300 includes a two-piece actuator with the pump actuator head 330 slidingly received into the top and into a cavity or hollow formed or defined by the tube interface 310. During use the pump actuator head 330 is depressed and caused to travel into the tube interface 310 causing two primary conditions: liquid from reservoir 208 is drawn into and through the tube assembly 220 and the pump assembly 300 and out actuator head nozzle or opening or outlet 332; and the usage measuring and indicating assembly advances or counts or causes the gear combination 344/346/350/352 to increment. Upon predefined number of instances, then the display wheel 350 if caused to position the set of indicia to display via the window 312 an indicia associated with a usage status.

FIG. 3B provides a top view of the pump actuator assembly with cross-sections shown associated with FIGS. 3C and 3D. FIG. 3C provides a front cross-sectional view of the pump actuator assembly 300 associated with an exemplary embodiment of the usage measuring and indicating mechanism 340. As shown, the gear combination 344/346/350/352 with axes are connected to and supported by the base or support 320 received in the hollow 316. Tab support 341 supports tab 342 and allows same to advance the secondary gear 344 along with single tooth wheel 346 upon each actuation of the pump assemble. FIG. 3D provides a side cross-sectional view of the pump actuator assembly 300 showing a display window 312 associated with an exemplary embodiment of the usage measuring and indicating mechanism 340. The assembly 340 is disposed within the hollow 316 and positioned so the display wheel 350 and set of display indicia 356 is properly aligned and viewable with display window 342. When the actuator head 330 is depressed conduit 334 comes in contact with the upper or top end 228 of the tube assembly 220 and causes the spring or bias member 232 to deflect and cause a pumping action to occur within the pump interface 224. FIG. 3E provides a side cross-sectional view of the pump actuator head 330 with conduit portion 334 in this exemplary embodiment of the usage measuring and indicating mechanism 340.

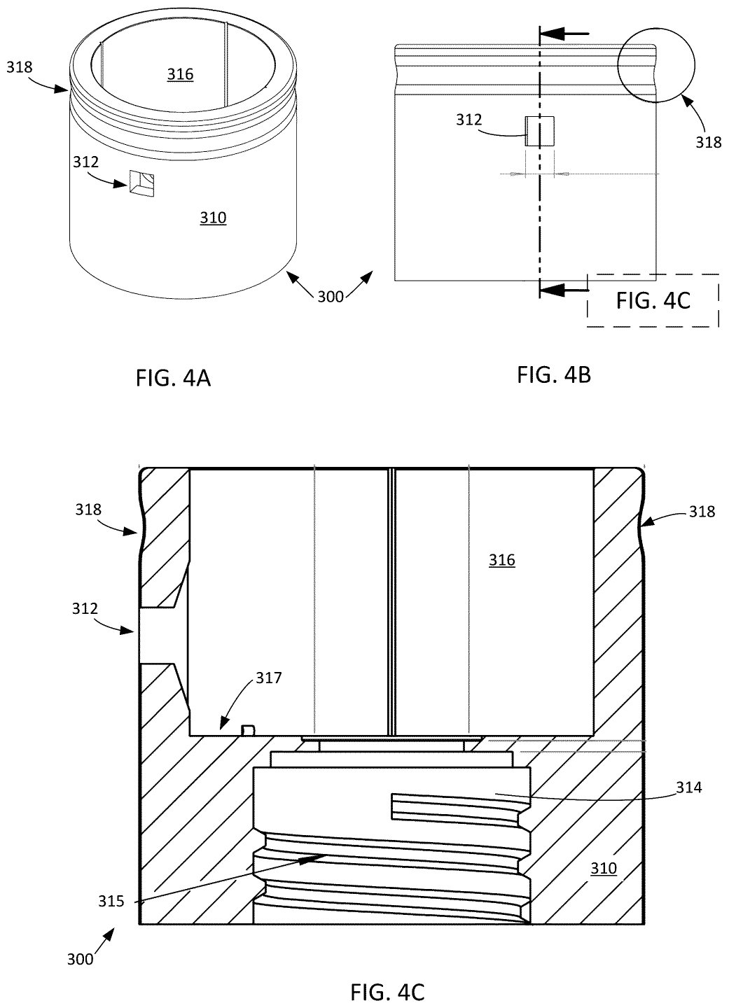

FIGS. 4A-4B provide perspective and front views of an exemplary tube interface component 310 for use in the exemplary pump actuator assembly for use with the liquid dispenser of FIG. 1A in accordance with a first embodiment of the present invention. As shown, tube interface 310 includes a window 312 formed therein as an opening to provide clear line of sight viewing of the aligned set of indicia 356 provided on the display wheel 350. A groove 318 is included along a top portion of the tube interface 310 to cooperate with snap balls or the like to facilitate engagement and secure closure of the protective cap 400 with the pump assembly 300.

FIG. 4C provides a side cross-section view of the exemplary tube interface component 310 showing a usage display window or opening 312 for use in the exemplary pump actuator assembly 300 for use with the liquid dispenser of FIG. 1A in accordance with a first embodiment of the present invention. As shown, internal threaded portion 314 with threads 315 is configured to threadingly mate with external threaded portion of neck 210 in a secure fashion and to prevent leakage of product stored in reservoir 208 and that travels through the tube assembly 220 and the pump assembly 300. With the tube interface 310 secured to the neck 210 of bottle or housing 200, the collar 230 is secured within the combined enclosure and positioned for contact with the conduit portion 334 of the actuator head 330.

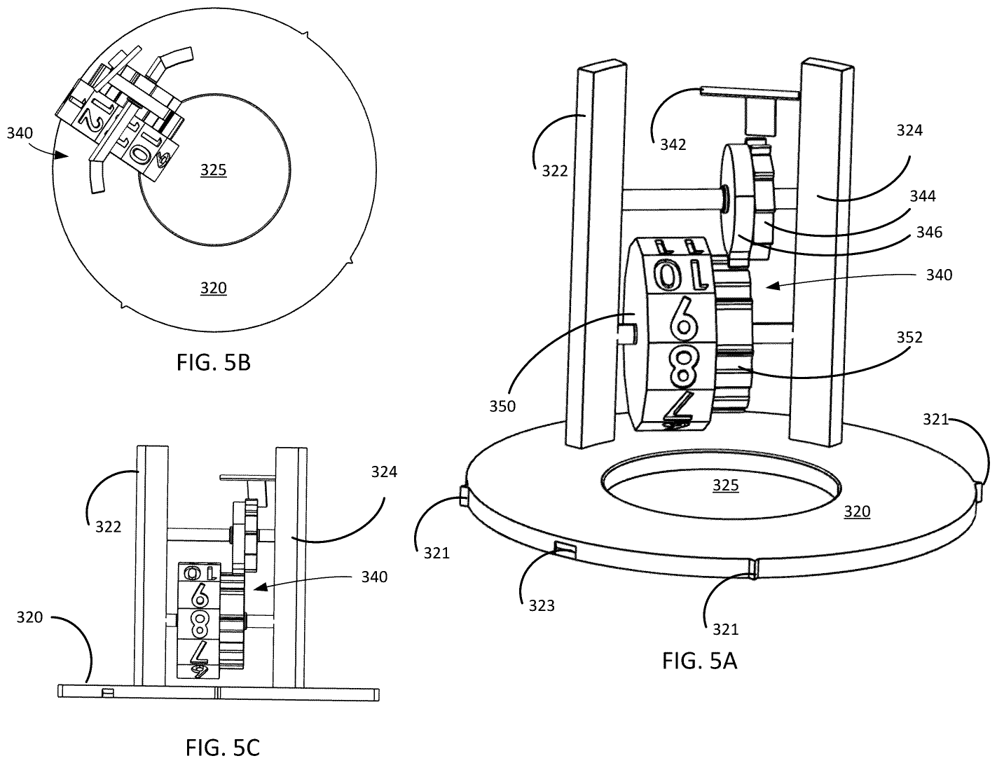

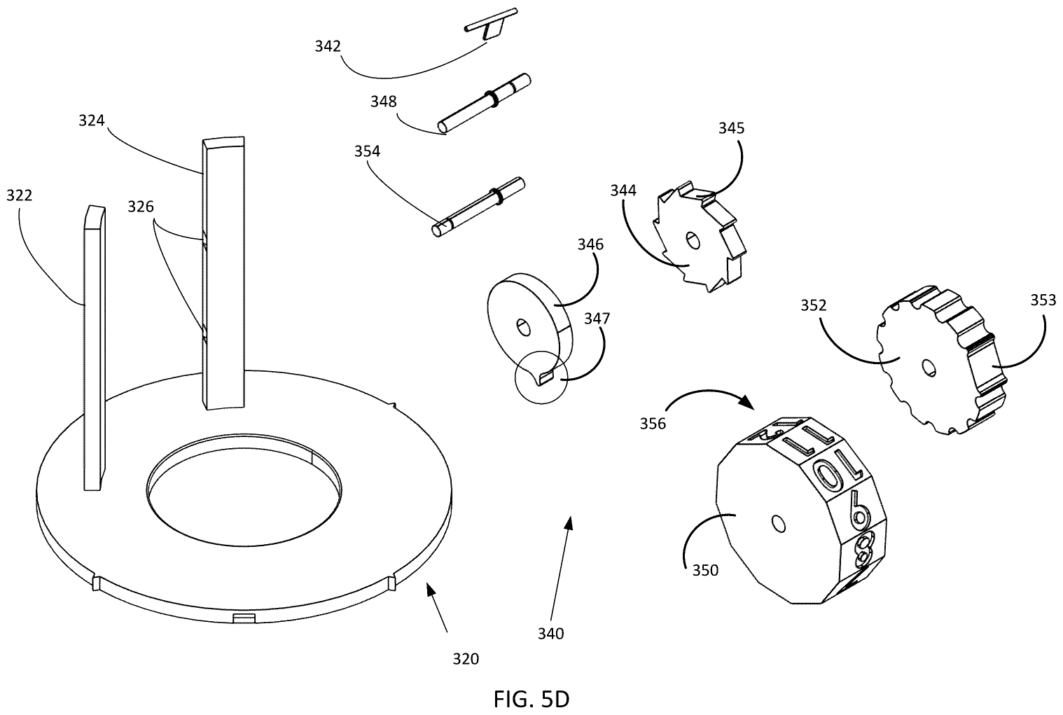

FIG. 5A provides a front perspective view of the exemplary usage measuring and indicating mechanism 340 for use with the exemplary pump actuator assembly 300 for use in accordance with the liquid dispenser of FIG. 1A in accordance with a first embodiment of the present invention. As shown, base or support 320 defines an opening or void 325 configured to permit free action of the pump assembly to contact the pump interface 224 of the pump tube assembly 220. A series of tabs 321 or similar features are provide to facilitate alignment of the usage measuring and indicating mechanism 340 with the window 312 of tube interface 310.

FIG. 5B provides a top-down perspective view of the exemplary usage measuring and indicating mechanism of FIG. 5A and FIG. 5C provides a front view of the exemplary usage measuring and indicating mechanism of FIG. 5A. FIG. 5D provides an exploded perspective view of the exemplary usage measuring and indicating mechanism 340 for use with the exemplary pump actuator assembly 300 for use in accordance with the liquid dispenser of FIG. 1A. As shown in the various views, depressing the actuator head 330 causes tab 342 to operate so as to drive a secondary gear tooth wheel 344 (e.g., a ten-tooth wheel), which in turn is connected to and drives single tooth wheel 346, which in turn drives primary gear tooth wheel 352 (e.g., 12-tooth wheel), which in turn is connected to and drives display wheel 350. FIG. 3D shows the alignment of the tab 342 with the secondary gear wheel 344 and single tooth wheel 346. As shown, primary gear tooth wheel 352 includes a flat 353 or gear wheel separation area to provide an end of count position.

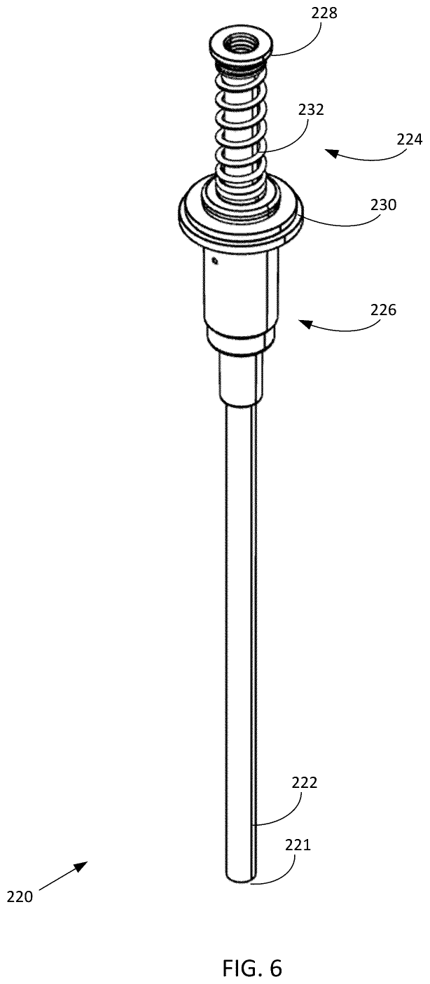

FIG. 6 provides a front perspective view of an exemplary pump tube assembly 220 for use in accordance with the liquid dispenser of FIG. 1A in accordance with a first embodiment of the present invention. As shown the pump tube assembly 220 includes an elongated tube or tube portion 222, an intermediate portion 226, a pump actuator interface 224 including a spring or biasing member 232, a pump base collar 230 and a top end 228. The elongated tube portion 222 of the pump tube assembly 220 is inserted into the reservoir 208 of the bottle or body or housing 200. As described above, the intermediate tube portion 226 supports the tube portion 222 with a first end supported by the pump actuator interface and defining an outlet, and a second opposite end defining an inlet 221 in communication with liquid product contained in the reservoir 208.

In one manner of operation, the present invention provides a system to track the pace at which customers use liquid products including personal care and beauty products (including, but not limited to those sold in a pump bottle). Tracking usage data helps providers understand optimal replenishment timeline (both in the context of new purchases, replenishments, and refillable systems). A mechanical counter system is integrated into the pump mechanism (“the pump”), suitable for both an atmospheric pump and an air-less pump. The operation works as follows. The customer presses the pump on the bottle every time they want to extract product from the bottle. A plastic gear inside the pump mechanism is activated with every press—in effect, this gear is mechanically counting how many times the pump has been pressed. It takes 10 presses of the pump to move to a “stopping point.” For example: <Start> 1, 2, 3, 4, 5, 6, 7, 8, 9 <Stopping Point A> 11, 12, 13, 14, 15, 16, 17, 18, 19 <Stopping Point B>21, 22, 23, 24 [ . . . ] 116, 117, 118, 119 <Stopping Point L>. In this example, there are a total of 12 stopping points (e.g., A, B, C, D, E, F, G, H, I, J, K, L), which equates to 120 presses. The pump bottle should be fully empty after the 120 presses. Each stopping point is indicated by a code within a small display panel on the pump bottle's neck. Each stopping point/code indicates how many times the pump actuator has been pressed, and thus, indicates roughly how much product has been used. In one exemplary manner, the code can only be understood by the retailer or provider (i.e., the customer will not understand what the code means). After 120 presses, the small display screen continues to show the final stopping point code (i.e., “Stopping Point L”) and does not rewind even if the customer keeps pressing the pump. The small display screen is a key part of the mechanical counter system, as it enables retailer or provider and the customer to communicate about how much of the product in the bottle has been used. A retailer or provider will reach out to each customer (via SMS, email, and other communication mediums) at a predefined time after purchase to ask them for the current code that they see on their pump bottle. A retailer or provider will use this information (the code provided, the time since purchase or last replenishment, and any other relevant customer information) to make business decisions as it relates to replenishment/restock management. This information will be used in a variety of ways (including, but not limited to AI/ML models that will predict/recommend optimal timing for replenishment). This information will also inform customer communication, website personalization, and other forms of targeting/communication with our customer.

In addition, the counter may be combined with the pump mechanism in a way that with every actuator press both mechanisms function simultaneously. The counter does not interfere or change the way the pump mechanism functions. The counters' gear system is located on top of the thread that connects between the glass container and the pump mechanism, thus allowing both actions to be performed simultaneously. Since the customer does not always press the pump actuator until the end, the invention includes a specific location (e.g., “press depth”) determined by the brand which “qualifies” as a press that is counted as part of the counter track. The inner plastic gear is planned in such a way that when the actuator is moving back up (using the spring of the pump) the motion of the gear will not be affected backwards. The counter only tracks when the customer is pressing down, and not when the actuator is released back up.

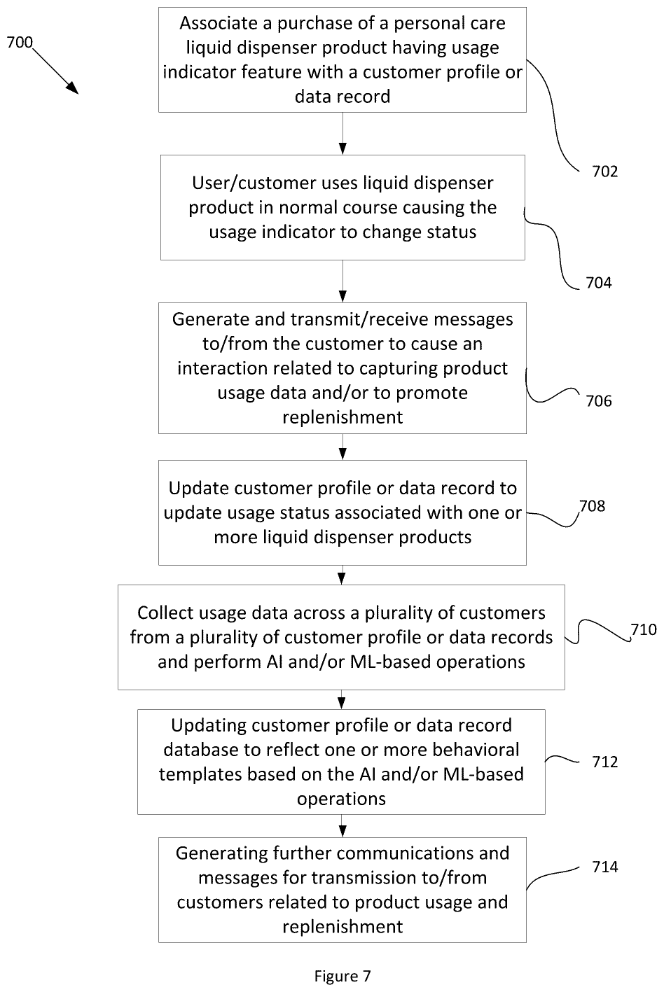

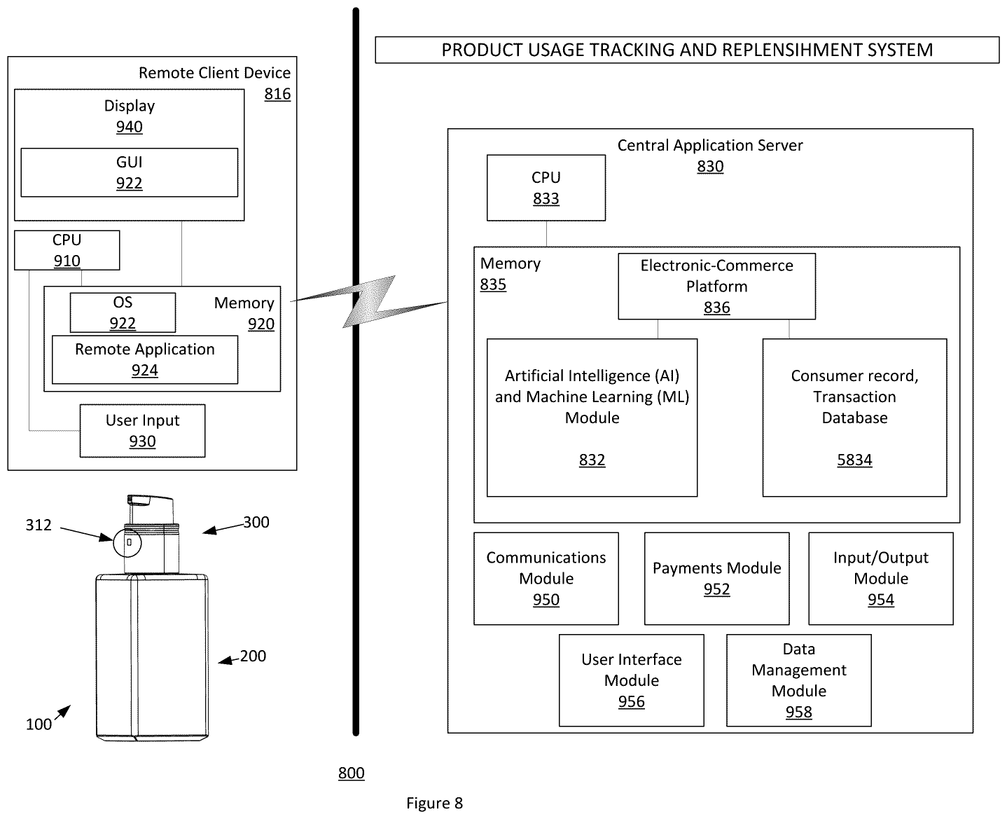

FIG. 7 illustrates an exemplary method or process of implementing a customer interaction and product replenishment operation for use in accordance with use of the liquid dispenser of FIG. 1A along with a communications network and remote devices (such as the system of FIG. 8) in accordance with a second embodiment of the present invention. As shown at step 702—an operation of the system includes associating a purchase of a personal care liquid dispenser product having usage indicator feature with a customer profile or data record. As shown at step 704—a user/customer uses liquid dispenser product in normal course causing the usage indicator to change status. As shown at step 706—the system generates and transmits/receives messages to/from the customer to cause an interaction related to capturing product usage data and/or to promote replenishment. As shown at step 708—an operator updates customer profile or data record to update usage status associated with one or more liquid dispenser products. As shown at step 710—the system collects usage data across a plurality of customers from a plurality of customer profile or data records and perform Artificial Intelligence (AI) and/or Machine Learning (ML) based operations

As shown at step 712—the system updates customer profile or data record database to reflect one or more behavioral templates based on the AI and/or ML-based operations. As shown at step 714—the system generates further communications and messages for transmission to/from customers related to product usage and replenishment.

FIG. 8 illustrates an exemplary schematic diagram of client-server architecture for use in accordance with capturing data and generating messages for use with the liquid dispenser of FIG. 1A in accordance with a third embodiment of the present invention.

System 800 facilitates enhanced customer experience in connection with usage of liquid product dispenser products 100 when combined with data collection and communications and messaging of a central system 830 connected to a user via a mobile device 816. The system 800 includes interacting with a first remote device 816 associated with a first user 810, the first user being a user of a liquid product dispensing product 100 of the type described herein above including with usage measuring and indicating capabilities. The system 800 includes interacting with a plurality of remote devices to collect data associated with a plurality of users/customers. The system 800 is configured to support and interact with a plurality of users including a plurality of consumer-type users. The system 800 includes a central application server 830 having a processor and a memory, the memory comprising computer executable code that when executed by the processor transforms the computer into a special purpose machine/system. The system 800 is adapted to receive from the first user, via a client-side user interface operating on the first remote device 816 connected over a communications network with the central server 830, one or more sets of content over a single session or multiple sessions. The sets of data related to usage of products associated with the entity operating the system 800.

The system 800 includes means for generating user interfaces for display at the remote user (consumer) device 816 for presenting user interfaces and collecting data of interest and related to the user, the product, replenishment of the product, transacting sales, and presenting product information or supporting information.

The remote devices may be PC-type machines or may be mobile-type devices, e.g., smart phones, PDAs, tablets or the like. The system of the above embodiment may further comprise a communications interface for establishing connection(s) with one or more third-party platforms or services, including social media services (e.g., Instagram), content delivery services (e.g., YouTube), private websites, and blogs. Such third-party platforms or services may also be used in connection with obtaining user generated data and/or presenting product related content to consumer-type users and/or consumer-type user content posting via one or more user interfaces served to the client-side remote devices during an online session.

While the invention has been described by reference to certain preferred embodiments, it should be understood that numerous changes could be made within the spirit and scope of the inventive concept described. Also, the present invention is not to be limited in scope by the specific embodiments described herein but only by the claims set forth below. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A liquid dispenser adapted to dispense a liquid personal care product, the liquid dispenser comprising:
a liquid product housing defining an interior product reservoir configured to receive and contain liquid product and having an output portion, the output portion including an outwardly protruding neck defining an opening and configured to receive and support a pump tube assembly;
the pump tube assembly comprising an elongated tube portion disposed within the liquid product reservoir and a pump actuator interface supported by the neck;
a pump actuator assembly having an inlet and an outlet, the pump actuator assembly having a tube interface component adapted to mate with the pump actuator interface; and
a product usage indicating mechanism configured to detect incremental use of the dispenser to dispense liquid product from the product reservoir and to indicate a status of the incremental usage.

2. The liquid dispenser of claim 1 wherein the product usage indicating mechanism includes a counter adapted to count each actuation of the pump actuator assembly.

3. The liquid dispenser of claim 1 wherein the product usage indicating mechanism includes a display in clear view from the exterior of the dispenser and showing in successive manner one indicia from a set of indicia representing a usage status.

4. The liquid dispenser of claim 3 wherein the set of indicia include one or more of the following: a series of numbers, a set of graphical images; a set of colors; a series of shaded images; and a set of markings.

5. The liquid dispenser of claim 1 wherein the product usage indicating mechanism comprises: a display wheel on which is disposed for sequential viewing a set of indicia; a primary gear wheel connected to the display wheel in a co-axial manner and configured to drive the display wheel in a rotating fashion about a common axis.

6. The liquid dispenser of claim 5 wherein the product usage indicating mechanism further comprises a tab configured to selectively cause the primary wheel to rotate upon a pre-defined number of pumping actions of the pump actuator assembly.

7. The liquid dispenser of claim 5 wherein the product usage indicating mechanism further comprises a secondary gear wheel configured to rotate about a second axis, and wherein the tab causes the secondary gear wheel to rotate upon a predefined instance of pumping actions of the pump actuator assembly.

8. The liquid dispenser of claim 1 wherein the product usage indicating mechanism further comprises a gear and axis base configured to support the display wheel and the primary gear wheel and the primary axis, wherein the gear and axis base is received within the tube interface of the pump actuator assembly.

9. The liquid dispenser of claim 1 wherein the elongated tube portion includes a first end supported by the pump actuator interface and defining an outlet, and a second end defining an inlet in communication with liquid product contained in the reservoir.

10. The liquid dispenser of claim 1 wherein the pump actuator interface and the tube interface provide a continuous path for liquid from the reservoir to pass into and through the pump tube assembly and the pump actuator assembly and upon actuation of the pump actuator assembly, cause liquid product contained in the reservoir to be drawn into the tube portion via the tube inlet, flow through the pump tube assembly, through the pump actuator assembly, and exit the pump actuator outlet for dispensing of the liquid product for use by a user.

11. The liquid dispenser of claim 1 wherein the neck includes a threaded exterior and the pump actuator includes an internal threaded portion adapted to threadingly mate with the threaded exterior of the neck.

12. The liquid dispenser of claim 1 wherein the liquid dispenser is adapted to removably receive a replaceable capsule and dispense a liquid personal care product contained in an installed capsule and the usage measuring and indicating mechanism is adapted to be reset upon product replenishment; and wherein the pump actuator interface is configured to alternately attach to and detach from the housing to allow, alternately, for insertion and removal of the cartridge to facilitate replacement of a spent cartridge with a fresh replacement cartridge.

13. The liquid dispenser of claim 1 wherein the pump engine is spring-biased and is actuated upon a user depressing a spray head provided on the liquid spray pump assembly to cause the pump engine to draw a pre-determined amount of liquid from the reservoir; and wherein the housing further comprises a support component adapted to removably attach to the top of the housing, the support component having a pump engine support portion adapted to join with and support the liquid spray pump assembly.

14. A method of dispensing liquid product and indicating usage status, the method comprising:
providing a liquid dispenser adapted to dispense a liquid personal care product from a product reservoir configured to receive and contain liquid product;
actuating a pump actuator assembly to cause liquid product contained in the product reservoir to flow out an output portion of the liquid dispenser, the pump actuator assembly having an inlet and an outlet;
detecting and displaying, by a product usage measuring and indicating mechanism, a usage condition, the product usage indicating mechanism configured to detect incremental use of the dispenser to dispense liquid product from the product reservoir and to indicate a usage status of the incremental usage; and
providing on the dispenser a clear view of the usage status indication.

15. The method of claim 14 further comprising counting, by the product usage indicating mechanism, each actuation of the pump actuator assembly.

16. The method of claim 14 further comprising displaying, by the product usage indicating mechanism, in clear view from the exterior of the dispenser indicia from a set of indicia representing a usage status; wherein the set of indicia include one or more of the following: a series of numbers, a set of graphical images; a set of colors; a series of shaded images; and a set of markings.
